(19) United States
(12) Patent Application Publication
(10) Pub. No.: US 2009/0027043 A1
(43) Pub. Date: Jan. 29, 2009

(54) ROLLER ENCODER

(75) Inventors: Wynn M. Pelak, Rockford, MI (US); Randall J. Carlson, Grand Rapids, MI (US); Daniel O. Amarandei, Kentwood, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: Dematic Corp., Grand Rapids, MI (US)

(21) Appl. No.: 12/172,663

(22) Filed: Jul. 14, 2008

Related U.S. Application Data
(60) Provisional application No. 60/952,022, filed on Jul. 26, 2007.

(51) Int. Cl. G01B 7/30

(52) U.S. Cl. 324/207.2

(57) ABSTRACT

An encoder is provided for a conveyor having a belt, a plurality of rollers supporting the belt and a motor for driving one of the rollers. The encoder includes a hall effect cartridge having at least one hall effect sensor. The hall effect cartridge is adapted to be mounted inside of one of the rollers supporting the conveyor. The encoder also includes a magnetic ring adapted to be mounted inside the roller and rotate with the roller, wherein the ball effect sensor monitors the rotation of the magnetic ring and generates a signal in the form of pulse data based on the rotation of the roller.

### CROSS REFERENCE TO RELATED APPLICATION

This application claims priority from U.S. provisional patent application Ser. No. 60/952,022 filed on Jul. 26, 2007, the disclosure of which is hereby incorporated herein by reference in its entirety.

### FIELD OF THE INVENTION

The present invention relates generally to belt conveyors and in particular to encoders for monitoring the movement of the belt.

### BACKGROUND OF THE INVENTION

It is known to use an optical sensor, such as pulse position indicator (PPI) encoder, to monitor the movement of a belt conveyor to obtain data relating to the speed and position of the conveyor. The PPI encoder is typically positioned in a wheel or other structure adapted to rotate with the belt of the conveyor, and generates tracking pulses based on the rotation of the wheel. For example, optical sensors in the encoder may watch for holes in the wheel to monitor the rotation of the wheel.

The wheel containing the PPI encoder is typically positioned adjacent to or under the belt portion of the conveyor. Thus, movement of the belt causes the wheel to rotate. However, sufficient contact between the wheel and the belt may not be ensured. For example, the lacing or seam of the belt may bump or shift the wheel from the conveyor belt, thus causing a disruption in the signal produced by the encoder.

### SUMMARY OF THE INVENTION

The present invention provides an encoder for a belt conveyor, which provides information relating to the belt, such as the speed of the belt, the speed of the roller or the position of a package on the belt. The invention may include either a plurality of rollers or a plate for supporting the belt and a motor for driving one of the rollers. The encoder according to an aspect of the present invention includes a hall effect cartridge having at least one hall effect sensor, which is adapted to be mounted inside of one of the rollers. Also included is a magnetic ring adapted to be mounted inside the roller and rotate with the roller. The hall effect sensor monitors the rotation of the magnetic ring and generates a signal in the form of pulse data based on the rotation of the magnetic ring.

Optionally, the encoder may include a bearing housing adapted to support the hall effect cartridge in the roller. A bearing ring having a plurality of ball bearings may be positioned in the bearing housing, such that the bearing housing and the roller rotate on the plurality of ball bearings.

The encoder may also include a circuit board connected to a connector by cables. The connector provides pulse data from the hall effect cartridge to the circuit board, which translates the pulse data into output readable by either a PC or a PLC. The pulse data generated by the hall effect cartridge may provide information such as the speed of the roller, the speed of the belt or the position of at least one package on the belt.

Optionally, the encoder may include at least one transistor terminated to the connector.

Further, the motor may be a variable frequency drive unit motor.

Thus, the embodiments of the present invention provide an encoder for a roller of a belt conveyor, having a hall effect cartridge adapted to be mounted in a roller that drives the belt. This configuration ensures that the encoder will provide accurate data regarding speed, movement and position of the belt. Because the roller and parts of the encoder are rotating with the belt, the encoder will not be bumped or shifted from the belt. Thus, the encoder of the present invention provides an accurate signal from which information relating to the belt can be obtained.

These and other objects, advantages, purposes, and features of the present invention will become apparent upon review of the following specification in conjunction with the drawings.

### BRIEF DESCRIPTION OF THE DRAWINGS

FIG. 1 is a front view of a belt conveyor having an encoder according to the present invention;

FIG. 2 is a front view of an alternative belt conveyor having an encoder according to the present invention;

FIG. 3 is a sectional view of an encoder according to the present invention;

FIG. 4 is a lower perspective view of the encoder according to the present invention;

FIG. 5 is an upper perspective view of the encoder of FIG. 4;

FIG. 6 is a bottom view of the encoder of FIGS. 4 and 5;

FIG. 7 is side view of the encoder of FIGS. 4 and 5;

FIG. 8 is a front view of a circuit board according to the present invention;

FIG. 9 is a graph showing the signal provided by the hall effect sensors of the encoder according to the present invention;

FIG. 10 is a schematic view of the system of the present invention;

FIG. 11 is a diagram of a circuit according to the present invention; and

FIG. 12 is diagram of another circuit according to the present invention.

### DESCRIPTION OF THE PREFERRED EMBODIMENTS

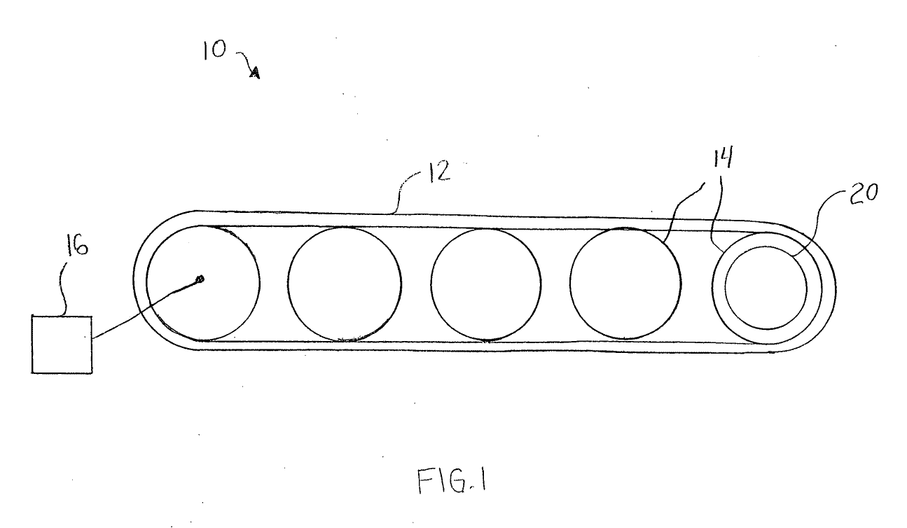

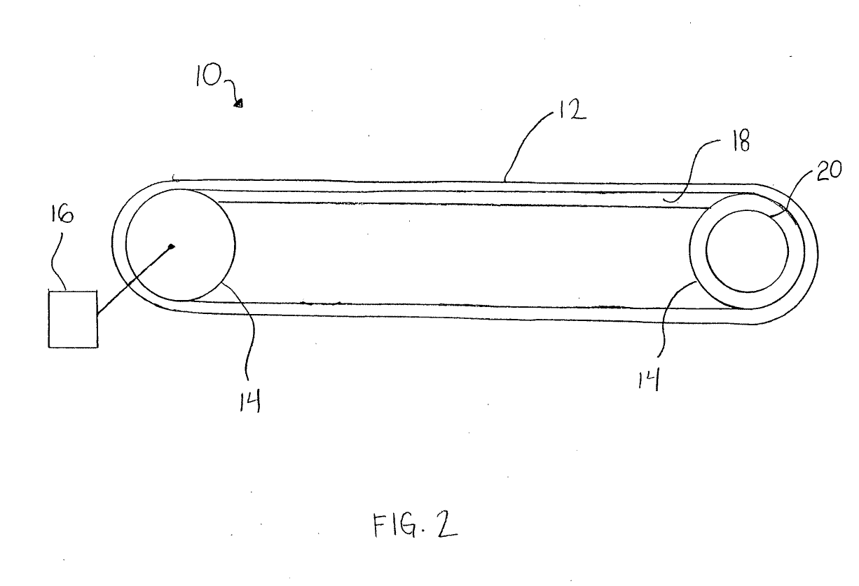

Referring now to the drawings and embodiments illustrated therein, an encoder 10 is provided for a conveyor having a belt 12 supported by a plurality of rollers 14 (FIG. 1). Optionally, belt 12 of the conveyor may also be supported by a plate 18, in addition to at least two rollers (FIG. 2). In either configuration, a power supply or motor 16, such as a variable speed drive motor, variable frequency or servo-controlled motor, is provided to drive at least one of the rollers.

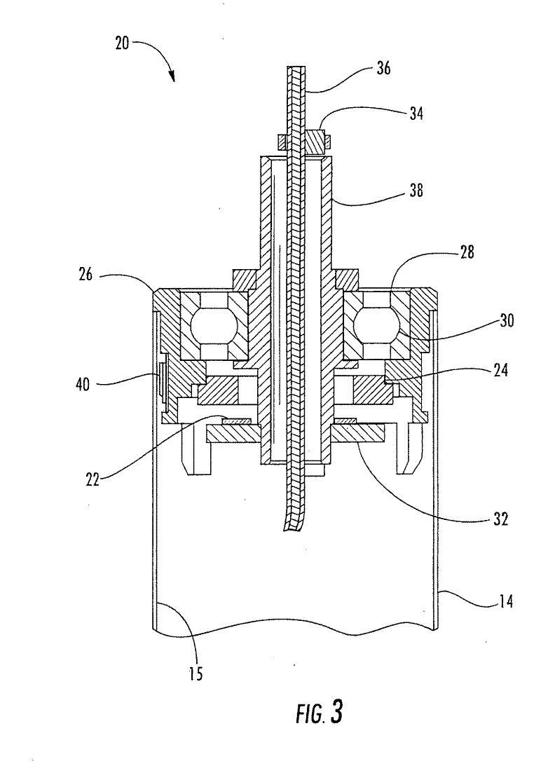

Encoder 10 includes a hall effect cartridge 20 that is adapted to be mounted inside one of the rollers 14. Encoder 10 further includes a magnetic ring 24, which is adapted to be mounted in hall effect cartridge 20 and rotate with the roller 14 in which it is contained (FIGS. 3-5). Hall effect cartridge 20 includes at least one hall effect sensor 22 for monitoring the rotation of magnetic ring 24. Based on the rotation of magnetic ring 24, hall effect sensor 22 generates a signal, such as in the form of pulse data. The pulse data can then be transferred or translated into useful, readable information regarding belt 12 of the conveyor, such as the speed of belt 12, the rotational speed of roller 14, or the position of a package on belt 12, as is known in the art.

Optionally, to facilitate the placement and mounting of hall effect cartridge 20 in roller 14, hall effect cartridge 20 may include a bearing housing 26 (FIG. 3). Bearing housing 26 may include a bearing ring 28, having a plurality of ball bearings 30, on which roller 14 and bearing housing 26 may rotate. Bearing housing 26 and bearing ring 28 allow some components or structures of the hall effect cartridge 20 to rotate with roller 14, for example, magnetic ring 24 is adapted to rotate with roller 14, while other components, such as hall effect sensor 22, remain stationary. Further, a tolerance ring 40 may be provided between bearing housing 26 and roller 14 to ensure a proper fit of hall effect cartridge 20 in the roller 14.

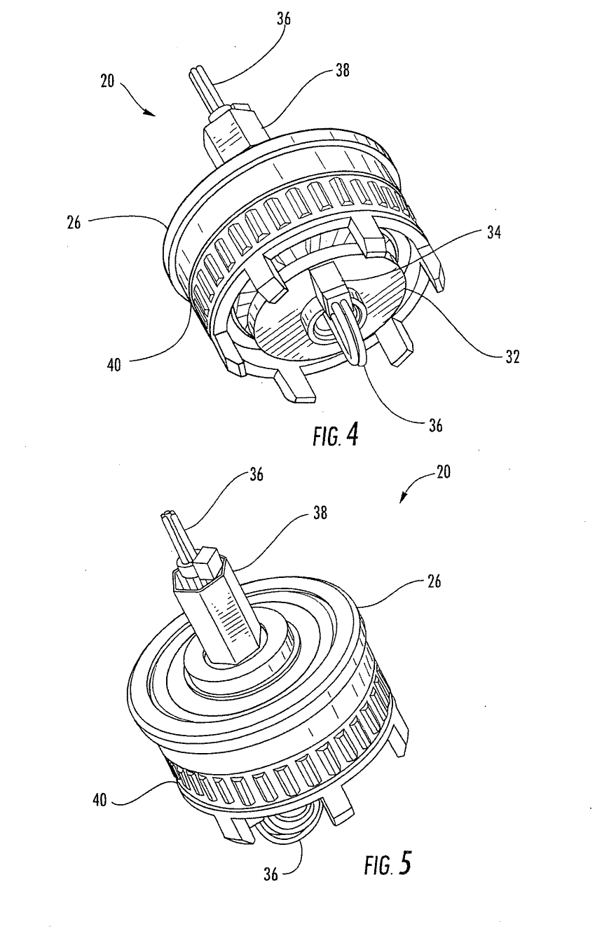

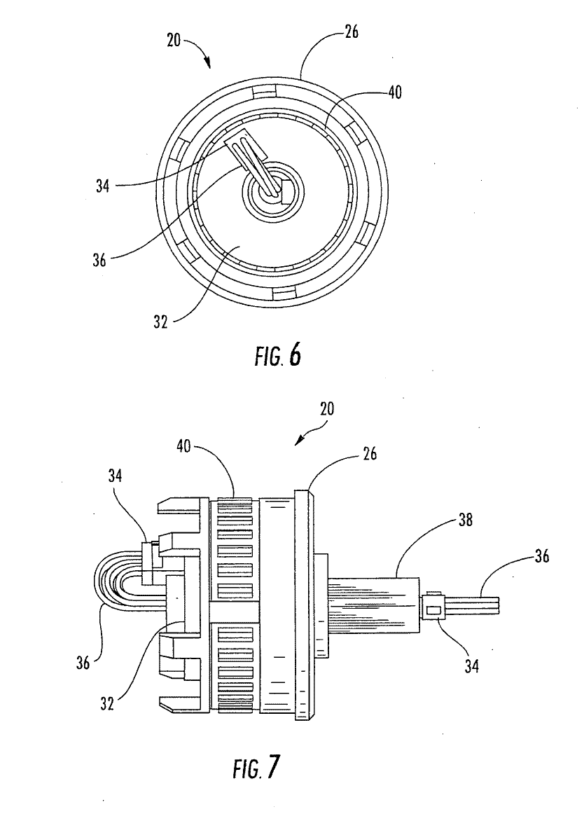

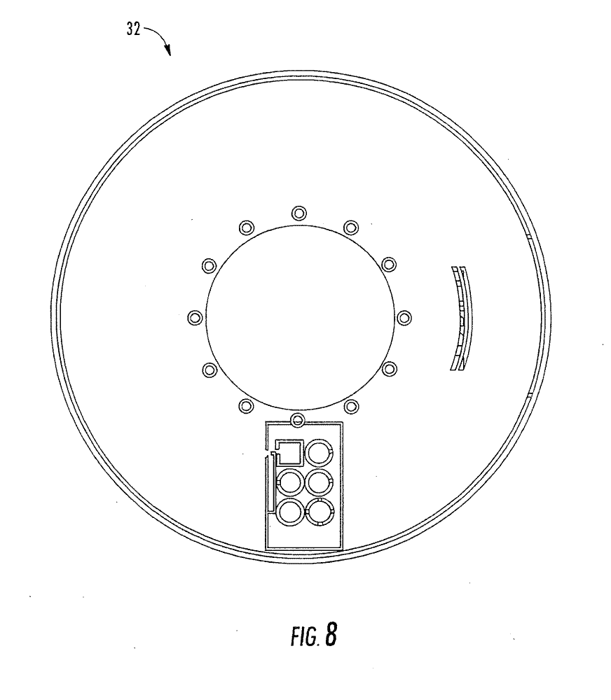

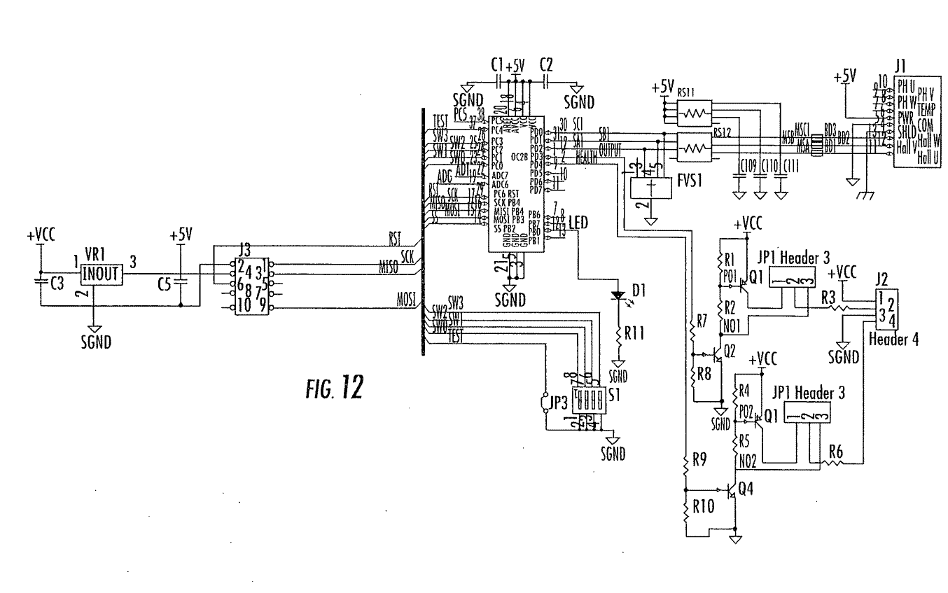

As previously stated, the hall effect sensor 22 generates a signal in the form of pulse data, which can then be translated to readable output. To facilitate the transfer of the data produced by ball effect sensor 22, a circuit board 32, a connector 34 and cables 36 may be provided (FIGS. 4-8). Hall effect sensor 22 is electrically connected to circuit board 32, which receives and translates the pulse data into output that is readable by a control unit, such as a microcomputer, PC or PLC. Connector 34 electrically connects circuit board 32 to a control unit, such as a microcomputer, a PC or a PLC via cables 36, which may be wired through hall effect cartridge 20 through a hexagonal shaft 38 (FIGS. 6 and 7). Thus, cables 36 are adapted to transfer data from circuit board 32 to the control unit, which is adapted to produce readable output (see circuit diagrams in FIGS. 11 and 12). Optionally, the output to the control unit may be 84 pulses per revolution of the magnetic ring. Further, only one pulse may be generated for every four pulses that are actually generated by the hall effect sensor. Thus, the encoder may only read a quarter of the signals produced.

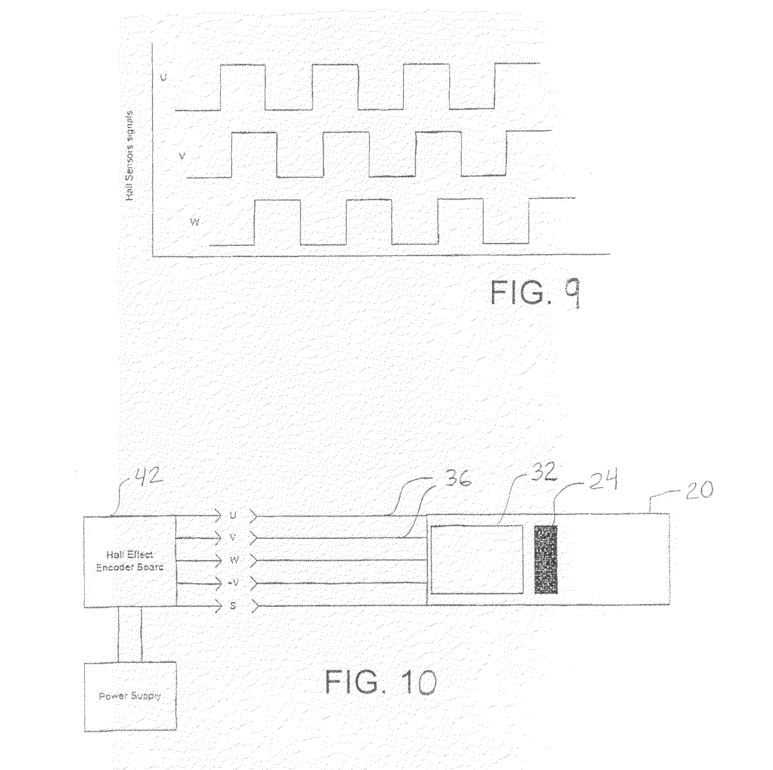

Optionally, to increase the accuracy of the data produced by the hall effect sensor, an encoder according to the present invention may include more than one hall effect sensor to produce more than one signal. For example, three hall effect sensors may be included in the hall effect cartridge to produce three separate signals, U, V, W, each of which is based on the rotation of magnetic ring 24. Because the hall effect sensors are spaced apart along the hall effect cartridge, the signals produced by the hall effect sensors may be staggered, as shown in FIG. 9, to reflect the different positions of the hall effect sensors. The three signals U, V, W may then be averaged to produce a signal that more accurately reflects the rotation of the magnetic ring, which may be translated into useful, readable information relating to the rotation of the roller and movement of the belt.

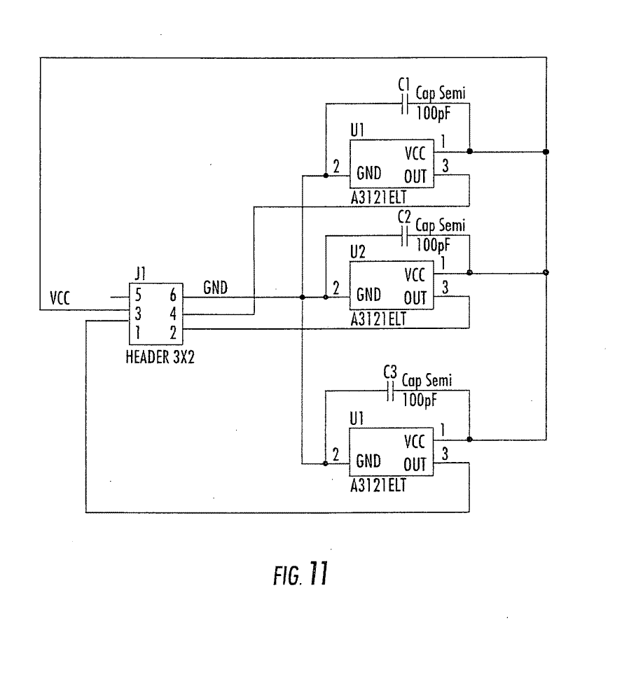

To facilitate the translation of the signals generated or transmitted by the hall effect sensors, the hall effect sensors may be connected via wires or cables to a control unit comprising a hall effect encoder board (FIG. 10). Encoder board 42 receives a plurality of cables 36, each of which corresponds to a hall effect sensor. The signal generated by the respective hall effect sensor is transmitted via its corresponding cable 36 to encoder board 42, which translates the signal to readable output.

Further, as discussed above, some components of encoder 10, including magnetic ring 24, are adapted to rotate with roller 14, while other components remain stationary. In the illustrated embodiment of FIG. 10, the hall effect sensors remain stationary, which not only allows the hall effect sensors to more accurately monitor the rotation of magnetic ring 24, but also prevents cables 36 from becoming tangled or twisted.

Thus, the present invention provides an encoder for a belt conveyor, designed to provide an electrical signal representative of the rotational speed of a roller of the conveyor to provide useful output regarding the speed of the roller, the speed of the belt, and further, the location of at least one package positioned on the belt. The encoder of the present invention is positioned inside of a roller supporting the belt conveyor, as opposed to being mounted in a wheel or the like positioned adjacent to the conveyor. The position of the encoder inside of the roller eliminates the need to maintain sufficient contact between the wheel and the conveyor belt.

Changes and modifications to the specifically described embodiments may be carried out without departing from the principles of the present invention, which is intended to be limited only by the scope of the appended claims as interpreted according to the principles of patent law including the doctrine of equivalents.

1. An encoder for a conveyor having a belt, the conveyor including a plurality of rollers supporting the belt and a motor for driving one of the rollers, comprising:
a hall effect cartridge having at least one hall effect sensor, said hall effect cartridge adapted to be mounted inside of one of the rollers; and
a magnetic ring adapted to be mounted inside said roller and rotate with said roller, wherein said at least one hall effect sensor monitors the rotation of said magnetic ring and generates a signal in the form of pulse data.

2. The encoder of claim 1, including a bearing housing adapted to support said hall effect cartridge in said roller, and including a bearing ring having a plurality of ball bearings positioned in said bearing housing, wherein said bearing housing and said roller rotate on said plurality of ball bearings.

3. The encoder of claim 2, including a tolerance ring positioned between said bearing housing and said roller.

4. The encoder of claim 2, including a connector and a circuit board connected to said connector by at least one cable, wherein said connector provides said pulse data from said hall effect sensor to said circuit board, wherein said circuit board translates said pulse data into output readable by one of a control unit.

5. The encoder of claim 4, wherein said pulse data provides at least one of the rotation of said roller, the speed of said roller, the speed of said belt and the position of at least one package on the belt.

6. The encoder of claim 5, wherein said output to said control unit is 84 pulses per revolution.

7. The encoder of claim 1, including three hall effect sensors, wherein each of said three hall effect sensors produces a signal based on rotation of the magnetic ring.

8. The encoder of claim 1, wherein said motor is a variable frequency drive unit motor.

9. A system for monitoring a conveyor driven by a motor, comprising:
a belt for the conveyor;
a plurality of rollers supporting said belt, wherein the motor is adapted to drive one of said rollers;
a hall effect cartridge having at least one hall effect sensor, said cartridge adapted to be mounted inside of one of said rollers; and
a magnetic ring adapted to be mounted inside said roller containing said hall effect cartridge and adapted to rotate with said roller, wherein said at least one hall effect sensor monitors the rotation of said magnetic ring and generates a signal in the form of pulse data.

10. The system of claim 9, including a bearing housing adapted to support said hall effect cartridge in said roller, and including a bearing ring having a plurality of ball bearings positioned in said bearing housing, wherein said bearing housing and said roller rotate on said plurality of ball bearings.

11. The encoder of claim 10, including a tolerance ring positioned between said bearing housing and said roller.

12. The system of claim 10, including a connector and a circuit board connected to said connector, wherein said connector provides said pulse data from said hall effect cartridge to said circuit board, wherein said circuit board translates said pulse data into output readable by one of a PC and PLC.

13. The system of claim 12, wherein said pulse data provides at least one of the rotational speed of said roller, the speed of the belt, and the position of at least one package on the belt.

14. The system of claim 13, wherein said output to said one of a PC and PLC is 84 pulses per revolution.

15. The system of claim 9, wherein said motor is a variable frequency drive unit motor.

16. The system of claim 9, including three hall effect sensors, wherein each of said three hall effect sensors produces a signal based on rotation of the magnetic ring.
